(19) United States
(12) Patent Application Publication
(10) Pub. No.: US 2024/0265495 A1
(43) Pub. Date: Aug. 8, 2024

(54) IMAGE PROCESSING APPARATUS, IMAGE PICKUP APPARATUS, AND IMAGE PROCESSING METHOD

(71) Applicant: CANON KABUSHIKI KAISHA, Tokyo (JP)

(72) Inventor: Taiki MASHIMO, Tokyo (JP)

(21) Appl. No.: 18/418,707

(22) Filed: Jan. 22, 2024

(30) Foreign Application Priority Data
Feb. 2, 2023 (JP) 2023-014919

(51) Int. Cl. G06T 5/20; G06T 5/70; G06T 5/73; G06V 10/74

(52) U.S. Cl. CPC G06T 5/20; G06T 5/70; G06T 5/73; G06V 10/761

(57) ABSTRACT

An image processing apparatus includes a memory storing instructions, and a processor configured to execute the instructions to acquire distance information about an in-focus position, and perform filter processing using an aberration filter determined based on the distance information and optical information about an optical system, for image data acquired using an image sensor. The aberration filter has a parameter for adjustment that makes closer to each other a characteristic of a first blurred image formed on an image plane due to defocus on a close distance side of the in-focus position, and a characteristic of a second blurred image formed on the image plane due to defocus on an infinity side of the in-focus position.

### BACKGROUND

### Technical Field

One of the aspects of the embodiments relates to an image processing apparatus, an image pickup apparatus, and an image processing method.

### Description of Related Art

Japanese Patent No. 6,516,410 discloses a technology for providing background blur using a filter suitable for a circuit scale by changing the number of times of filter processing and the filter accuracy depending on an object distance.

Recent lens apparatuses are often designed to improve resolving power. However, if the lens apparatus is designed to improve the resolving power, it becomes difficult to match the characteristic of a front blur image and the characteristic of a rear blur image. Although Japanese Patent No. 6,516,410 describes the background blur, it is silent about the way of matching the characteristic of the front blur image and the characteristic of the rear blur image and of expressing a proper blur.

### SUMMARY

An image processing apparatus according to one aspect of the embodiment includes a memory storing instructions, and a processor configured to execute the instructions to acquire distance information about an in-focus position, and perform filter processing using an aberration filter determined based on the distance information and optical information about an optical system, for image data acquired using an image sensor. The aberration filter has a parameter for adjustment that makes closer to each other a characteristic of a first blurred image formed on an image plane due to defocus on a close distance side of the in-focus position, and a characteristic of a second blurred image formed on the image plane due to defocus on an infinity side of the in-focus position. An image pickup apparatus having the above image processing apparatus also constitutes another aspect of the embodiment. An image processing method corresponding to the above image processing apparatus also constitutes another aspect of the embodiment.

Further features of the disclosure will become apparent from the following description of embodiments with reference to the attached drawings.

### BRIEF DESCRIPTION OF THE DRAWINGS

FIG. 1 is a block diagram of an image processing apparatus according to a first embodiment.

FIG. 2 explains a relationship between spherical aberration and a blurred image in the first embodiment.

FIGS. 3A and 3B explain a relationship between defocus and blur in the first embodiment.

FIGS. 4A and 4B explain changes in a modulation transfer function (MTF) at a certain defocus position in a case where an aberration providing filter according to the first embodiment is applied.

FIGS. 5A and 5B explain changes in MTF at a certain frequency in a case where the aberration providing filter according to the first embodiment is applied.

FIG. 6 is a flowchart of filter processing according to the first embodiment.

FIG. 7 is a flowchart of determination processing according to the first embodiment.

FIG. 8 is a block diagram of an image processing apparatus according to a second embodiment.

FIG. 9 is a block diagram of an image processing apparatus according to a third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

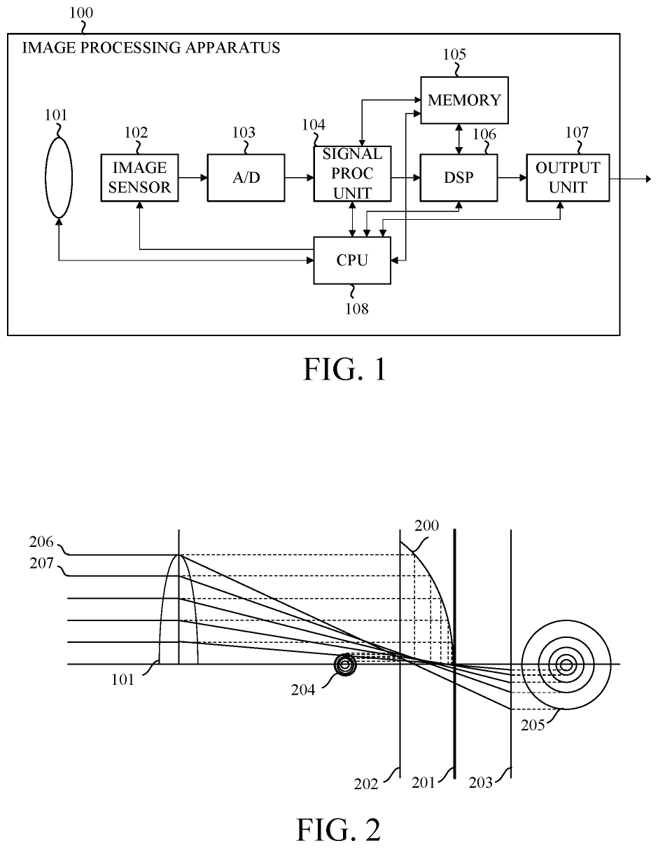

Referring now to FIG. 1, a description will be given of an image processing apparatus 100 according to a first embodiment. FIG. 1 is a block diagram of an image processing apparatus 100. The image processing apparatus 100 includes an imaging lens 101, an image sensor 102, an analog-to-digital (A/D) converter 103, a signal processing unit 104, a memory (storage unit) 105, a digital signal processor (DSP) 106, an output unit 107, and a CPU (acquiring unit) 108. In this embodiment, the DSP 106 is a filter processing unit that performs filter processing for image data using an aberration filter determined based on distance information and optical information about the imaging lens 101, as described below.

The imaging lens 101 is an optical system (imaging optical system) including a lens unit including a zoom lens, a focus lens, a shift lens, an aperture stop, and the like. The image sensor 102 is a photoelectric conversion element such as a CCD sensor or a CMOS sensor that converts an optical image (object image) formed by the imaging lens 101 into an electrical signal (analog signal), and includes a plurality of two-dimensionally arrayed pixels (pixel array). The image sensor 102 has two photoelectric conversion units in each pixel, and can read an electrical signal for phase difference detection from each photoelectric conversion unit. The A/D converter 103 converts the analog signal output from the image sensor 102 into a digital signal.

The signal processing unit 104 performs signal processing such as predetermined pixel interpolation, resizing processing (for example reduction), and color conversion processing, for the data (digital signal) output from the A/D converter 103. The data output from the A/D converter 103 is directly written into the memory 105 via the signal processing unit 104. The DSP 106 performs various image processing for the data output from the signal processing unit 104 or the data acquired from the signal processing unit 104 via the memory 105. The DSP 106 stores the image-processed data (image data) in the memory 105 or outputs it to the output unit 107.

The memory 105 stores image data or various data processed by the DSP 106. The memory 105 has sufficient storage capacity to store various data. The memory 105 includes a nonvolatile memory. The nonvolatile memory is an electrically erasable and recordable memory, such as EEPROM, and stores constants, programs, etc. for operations of the DSP 106 and/or the CPU 108. The program includes, for example, a program for causing the CPU 108, which is a computer, to execute the operations of each component in the image processing apparatus 100. The output unit 107 outputs the image data processed by the DSP 106 to an external device.

The CPU 108 controls each component in the image processing apparatus 100. The CPU 108 executes each processing described below based on the (computer) program stored in the memory 105. The memory 105 further includes a system memory. A RAM is used as the system memory, and constants and variables for the operation of the CPU 108, programs read out of the nonvolatile memory, and the like are loaded in the RAM.

### Relationship Between Spherical Aberration and Blurred Image

Referring now to FIG. 2, a description will be given of a relationship between spherical aberration and a blurred image. FIG. 2 explains a relationship between spherical aberration and the blurred image, and illustrates how light rays passing through the upper half of the imaging lens 101 form an image on the imaging surface.

In FIG. 2, reference numeral 200 denotes the spherical aberration of the imaging lens 101. As the image height becomes higher (the position separates from the optical axis in the direction perpendicular to the optical axis), the focus of the light ray shifts according to the spherical aberration 200 and a blur occurs. In a case where the imaging surface is located at a focus position 201 of the lens, the blur is minimized, and in general, in-focus is achieved by designing the imaging lens 101 so that it falls within a permissible circle of confusion. In a case where the imaging surface shifts back and forth from the focus position 201 (such as a position 202 or 203), imaging positions of the rays are shifted and spread in the image height direction and form a blurred image (such as a front blurred image (first blurred image) 204 or a rear blurred image (second blurred image) 205).

At this time, since the densities of the imaging light rays are different between the positions 202 and 203, the front blurred image and the rear blurred image have different appearances (optical characteristics such as aberration characteristics). More specifically, it is understood that in a rear blur 205, the widths of the imaging rays gradually change and form a blurred image with gradation. On the other hand, it is understood that in a front blur 204, rays 206 and 207 overlap each other and form a blurred (double-line blur) image in which the outline of the peripheral portion stands out.

Here, in order to optically match the shape of the front blur and the shape of the rear blur with respect to the in-focus position of the imaging lens 101, the spherical aberration may be zero. In a case where the spherical aberration is set to zero, the spherical aberration 200 becomes linear in the image height direction, and the appearances of the front and rear blurred images match. However, it is generally technically difficult to design a lens having no spherical aberration, and the lens becomes larger. Therefore, in general, spherical aberration 200 does not form a straight line in the image height direction, but characteristically spreads in front or behind the focus position 201. At this time, the front blurred image and the rear blurred image look different from each other. That is, in a case where the front blur image becomes soft, the rear blur image tends to become sharp (double-line blur), and on the other hand, in a case where the front blur image becomes sharp (double-line blur), the rear blur image tends to become soft.

### Relationship Between Defocus and Blur

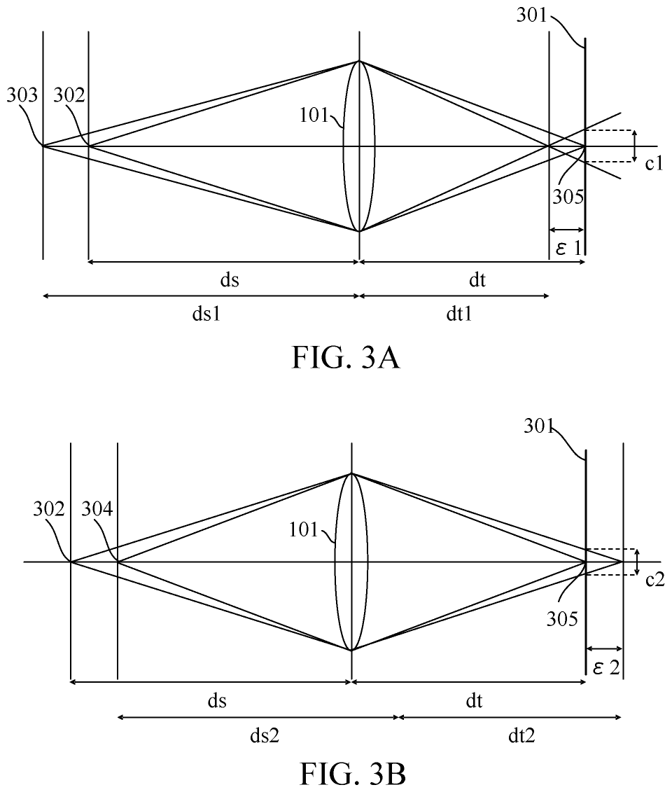

Referring now to FIGS. 3A and 3B, a description will be given of a relationship between defocus and blur. FIGS. 3A and 3B explain a relationship between defocus and blur, and illustrate a relationship between an object in real space and an image on an imaging surface.

The image sensor 102 is disposed on an imaging surface 301, and rays emitted from the object pass through the imaging lens 101 and form an image on the imaging surface 301. An object 302 is an object that is in-focus on the imaging surface 301, an object 303 is an object located on the infinity side of the in-focus object, and an object 304 is an object located on the close distance side of the in-focus object. Where |ε| is a magnitude (absolute value) of a distance from the imaging position of the object to the imaging surface, ε is defined as a defocus amount. The in-focus object 302 has ε=0 and is imaged at a point 305 on the imaging surface. The object 303 on the infinity side has ε<0 (front focus, rear blur), and spreads with a width c1 in the image height direction from the point 305, and is imaged in a blurred state. The object 304 on the close distance side has ε>0 (rear focus, front blur), spreads with a width of c2 in the image height direction from the point 305, and is imaged in a blurred state.

Regarding the object 303 on the infinity side, the following relationship is established from the lens formula (mapping formula),

$$1 / ds + 1 / dt = 1 / f$$

where f is a focal length of the imaging lens 101. The rays that have passed through the lens from the object 303 intersect the optical axis on the imaging surface side, intersect, and form an image on the imaging surface. At this time, the following relationship is established since two triangles formed by the rays on the imaging surface side of the lens have a relationship of similarity:

$$( dt - ε 1 ) : ε 1 = D : c 1$$

where ds is an object distance to the in-focus object 302 on the optical axis, dt is an image distance on the optical axis, ε1 is a defocus amount, and D is an aperture diameter of the imaging lens 101. The image distance dt is a distance from the imaging surface 301 to the imaging lens 101, and the object distance ds is a distance from the object 302 to the imaging lens 101. Therefore, the blur spread c1 is given as follows:

$$c 1 = ( ε 1 / ( dt - ε1 ) ) \times ( f / Fno ) , ε 1 < 0 \\ dt = ( L \pm √ ( L \hat{} 2 - 4 fL ) \text{)/} 2$$

where L is an imaging distance of the imaging lens 101, which is expressed as L=ds+dt, and Fno, which is an F-number (aperture value) is expressed as Fno=f/D.

Similarly, where ε2 is a defocus amount, the blur spread c2 is expressed as follows:

$$c 2 = ( ε2 / ( dt + ε 2 ) ) \times ( f / Fno ) , ε2 > 0$$

Therefore, the blur width is determined by the defocus amount, focal length, imaging distance, and F-number. It is conceivable that the aberration characteristic data has characteristics relating to the defocus amount, focal length, imaging distance, and F-number. It is also conceivable to design a filter that makes closer to each other the blurs in regions where the distances (ε1 and ε2) from the in-focus position are close, or c1 and c2.

Where a distance from the object 303 at infinity the imaging lens 101 is an object distance ds1, a relationship between the object distance ds1 and an image distance dt1 that is a distance from the imaging surface 301 to the imaging lens 101 is expressed as follows:

$$1 / ds 1 + 1 / dt 1 = 1 / f$$

Similarly, where a distance from the closest object 304 to the imaging lens 101 is an object distance ds2, a relationship between the object distance ds2 and an image distance dt2 that is a distance from the imaging surface 301 to the imaging lens 101 is expressed as follows:

$$1 / ds 2 + 1 / dt 2 = 1 / f$$

### Relationship Between Blur and Filter Processing

A description will now be given of a relationship between blur and filter processing. An actual object R, a deteriorated characteristic (optical transfer function: OTF) F due to blur, and image data P from the image sensor 102 have a relationship using a convolution filter of the deteriorated characteristic F, and a frequency domain to which Fourier transform is applied is expressed using a product as follows:

$$P = F ( R )$$

Assume that the object R is an ideal point light source. Where F1 is a blur characteristic of the object 303 on the infinity side, P1 is image data, F2 is a blur characteristic of the object 304 on the close distance side, and P2 is image data, each deteriorated image is expressed as follows:

$$P 1 = F 1 ( R ) P 2 = F 2 ( R )$$

An aberration providing filter F21 that converts a front blur image into a rear blur image is expressed as follows:

$$F 12 = P 1 ( P 2 - 1 ) = F 1 ( R ) ( P 2 - 1 ) = F 1 ( F 2 - 1 ) ( P 2 ) ( P 2 - 1 ) = F 1 ( F 2 - 1 )$$

Similarly, an aberration providing filter F12 that converts the rear blurred image into the front blurred image is expressed as follows:

$$F 21 = P 2 ( P 1 - 1 ) = F 2 ( R ) ( P 1 - 1 ) = F 2 ( F 1 - 1 ) ( P 1 ) ( P 1 - 1 ) = F 2 ( F 1 - 1 )$$

Thereby, one of the front blurred image and the rear blurred image can be converted into the other.

### Relationship Between MTF and Defocus

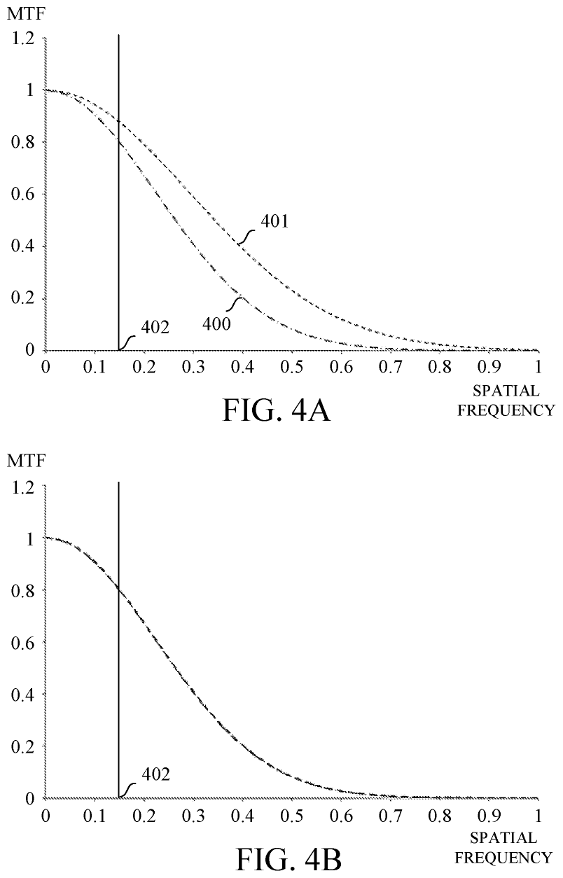

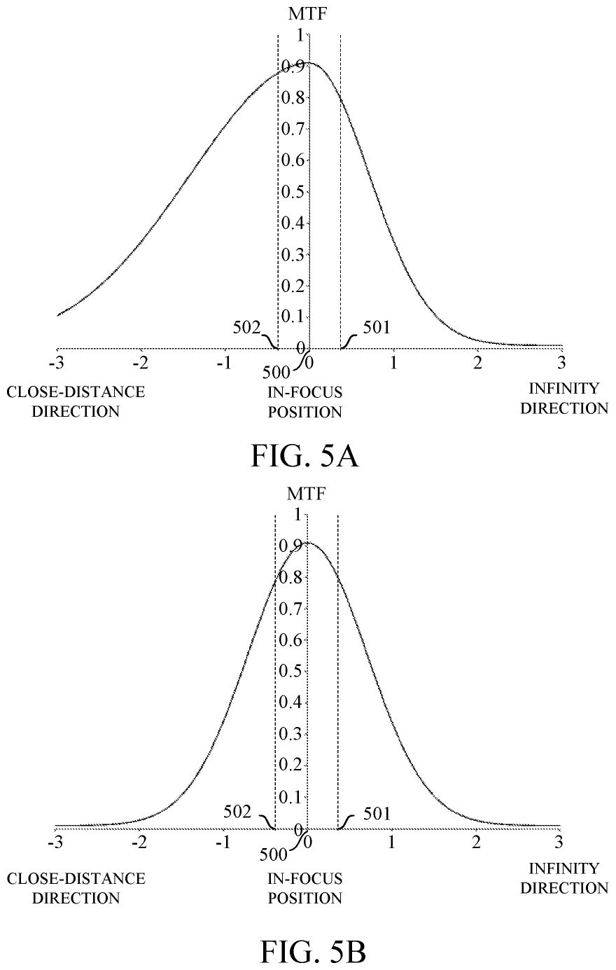

Referring now to FIGS. 4A, 4B, 5A, and 5B, a description will be given of a relationship between MTF and defocus. FIGS. 4A, 4B, 5A, and 5B illustrate the MTF characteristics of the OTFs F1 and F2 of the front blurred image and the rear blurred image. MTF is an amplitude characteristic of an OTF, and is used to understand a spatial frequency characteristic.

Referring now to FIGS. 4A and 4B, a description will be given of changes in MTF in a case where an aberration providing filter is applied. FIGS. 4A and 4B illustrate the MTF characteristic of the deteriorated characteristic F1 of the rear blurred image and the deteriorated characteristic F2 of the front blurred image at a certain defocus amount. In FIGS. 4A and 4B, a horizontal axis represents a spatial frequency, and a vertical axis represents MTF. Reference numeral 401 denotes an MTF of the deteriorated characteristic F1 of the rear blurred image, and reference numeral 400 denotes an MTF of the deteriorated characteristic F2 of the front blurred image. FIG. 4A illustrates an example in which the rear blurred image is sharp and the front blurred image is soft. Therefore, the MTF 401 is higher than the MTF 400 in a higher frequency region. By applying the aberration providing filter F21, the MTF can be matched as illustrated in FIG. 4B, and the front and rear blurs can be matched.

Referring now to FIGS. 5A and 5B, a description will be given of changes in MTF in the defocus direction in a case where an aberration providing filter is applied. FIGS. 5A and 5B illustrate MTF characteristics of the deteriorated characteristic F1 of the rear blurred image and the deteriorated characteristic F2 of the front blurred image corresponding to a frequency 402 in FIG. 4A. In FIGS. 5A and 5B, a horizontal axis represents a defocus amount, and a vertical axis represents MTF.

Point 500 represents an in-focus position where a defocus amount is zero, a direction in which the defocus amount is positive represents the MTF corresponding to the front blurred image, and a direction in which the defocus amount is negative represents the MTF corresponding to a rear blurred image. Similarly to FIG. 4A, FIG. 5A illustrates an example in which the rear blur is sharp and the front blur is soft. Therefore, the negative region has a higher frequency MTF than that of the positive region. Reference numeral denotes a defocus amount corresponding to the MTF 400 in FIG. 4A, and reference numeral 502 denotes a defocus amount corresponding to the MTF 401.

Here, applying the aberration providing filter F21 while changing it according to the defocus amount can match the MTFs as illustrated in FIG. 5B and match the front and rear blurs. That is, the blur sizes and blur shapes can be made equal to each other between the blurred images at positions in the close distance direction and the blurred images at positions in the infinity direction where the shift degrees from the in-focus position (for example, the defocus degrees) are equal to each other. At this time, it is also conceivable that the front blurred image and the rear blurred image are not completely matched (at least a pair of the blur sizes and the blur shapes are not matched). In general optical correction, a perfect match correction may cause artifacts due to image processing or may amplify noise. Therefore, in reality, it is conceivable to weaken the correction by viewing the image quality after implementation. For example, it is conceivable to suppress shoot due to edge enhancement or weaken a contour enhancement gain so that the MTFs do not completely match in FIG. 4A by applying a lowpass filter (LPF) to the aberration providing filters F12 and F21.

In areas near the in-focus position where the defocus amounts are small to a certain extent and no large blurs occur, blur shapes are not complicated, so the MTF characteristics can be made closer to each other by changing the edge enhancement and blurring processing using the optical information and the defocus amount of the lens without strictly calculating the aberration providing filter F21.

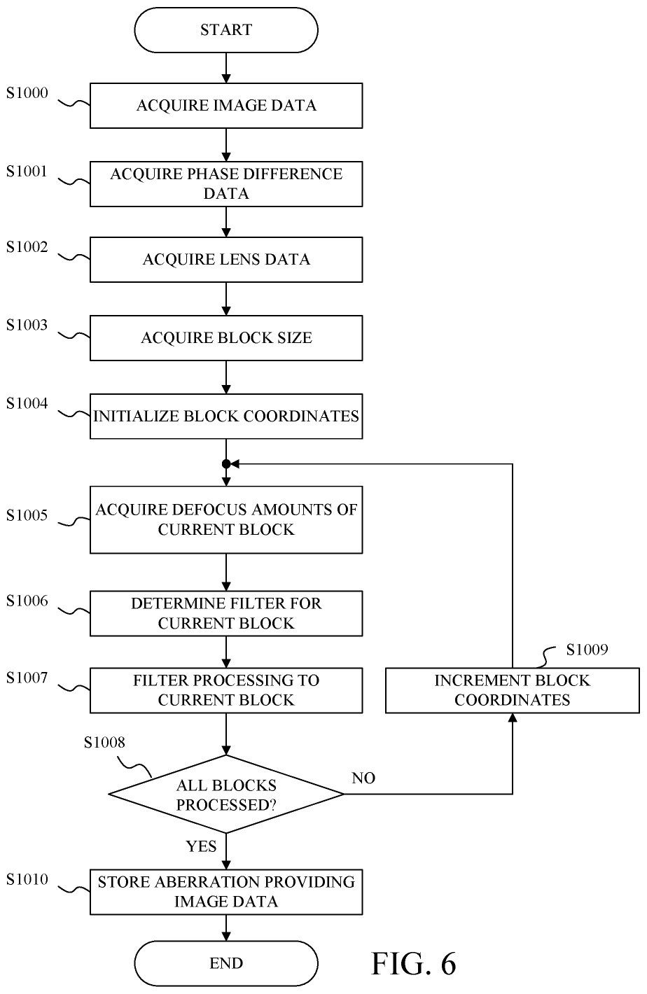

Referring now to FIG. 6, a description will be given of filter processing (image processing method) for providing aberration to make closer to each other the front blurred image and the rear blurred image. FIG. 6 is a flowchart of this filter processing. A program based on the flowchart of FIG. 6 is recorded in the nonvolatile memory of the memory 105. This program is loaded into RAM and executed by the CPU 108.

First, in step S1000, the CPU 108 reads image data acquired using the image sensor 102, converts it into a digital signal using the A/D converter 103, performs proper processing using the signal processing unit 104, and stores the processed image data in the memory 105. Next, in step S1001, the CPU 108 reads phase difference data from the image sensor 102, converts it into a digital signal using the A/D converter 103, performs proper processing using the signal processing unit 104, converts the post-processing phase difference data into a digital signal, and store the data in memory 105.

Next, in step S1002, the CPU 108 acquires lens data (optical information) about an aperture diameter, focal length (zoom), and imaging distance (focus) of the imaging lens 101, and stores it in the memory 105. The CPU 108 further acquires aberration providing data of the imaging lens 101 and stores it in the memory 105. Here, the aberration providing data is expressed by an aberration providing filter table in which a filter kernel of filter processing executed by the DSP 106 is expressed as table data of the aperture diameter, focal length, imaging distance, and defocus amount. The filter kernel is, for example, design data in which the aberration providing filter F21 or F12 described above is previously calculated based on the aperture diameter, focal length, imaging distance, and defocus amount.

This may be configured as data in the frequency domain, or may be configured as data in the spatial domain by applying an inverse Fourier transform to the aberration providing filter F21 or F21. A proper filter may depend on whether the filter processing of the DSP 106 is a spatial filter or a frequency filter. In designing the spatial filter, for example, each table element has a filter kernel acquired by the inverse Fourier transform of the aberration providing filter F21 or F12 as 64×64 two-dimensional data.

The aberration providing filter table may be discrete thinned-out data for the aperture diameter, focal length, imaging distance, and defocus amount based on the certain number of table divisions. For example, regarding the aperture diameter, the aperture diameter can range from a maximum open aperture to a minimum aperture. The filter kernel may be calculated by dividing this range into four parts, by acquiring a filter kernel for a particular aperture diameter as divided points, and by interpolating a value between the divided points using linear interpolation or the like. This embodiment acquires the aberration providing data from the imaging lens 101, but is limited to this example. For example, aberration providing data stored in the nonvolatile memory of the memory 105 may be acquired.

Next, in step S1003, the CPU 108 acquires the block size from the memory 105. The block size is used to vary the filter processing performed by the DSP 106 for each block area. Next, in step S1004, the CPU 108 sets block coordinates to the initial position in order to divide the image data into blocks and sequentially perform filter processing. The initial position is, for example, the upper left corner of the image coordinate system, but is not limited to this example.

Next, in step S1005, the CPU 108 determines the current block area based on the block size determined in step S1003 and the current block coordinates, and acquires phase difference data corresponding to the current block area from the memory 105. In addition, the CPU 108 calculates a representative value of the phase difference data in the current block area by performing predetermined processing for the acquired phase difference data. The predetermined processing is, for example, addition averaging, weighted averaging, or processing using center position data as a representative value, but is not limited to these examples. The CPU 108 calculates the defocus amount by multiplying the representative value of the phase difference data by a predetermined coefficient for converting it into the defocus amount. The predetermined coefficient may be acquired from the imaging lens 101 in obtaining lens data in step S1002, or may be stored in the nonvolatile memory of the memory 105.

Next, in step S1006, the CPU 108 determines the filter kernel to be applied from the aberration providing filter table based on the aperture diameter, focal length, imaging distance, and defocus amount corresponding to the current block area acquired in step S1002. At this time, in a case where the aberration providing filter table have discrete data by storing filter kernels only at specific divided points, as described in step S1002, a detailed filter kernel can be calculated by interpolating a value between divided points.

Next, in step S1007, the CPU 108 performs convolution filter processing using the DSP 106. The DSP 106 applies a convolution filter to the current block area using the filter kernel determined in step S1006. Next, in step S1008, the CPU 108 compares the current block coordinates with the end block coordinates calculated from the image data size, and determines whether filter processing has been completed for all blocks. In a case where it is determined that all blocks have been completely processed, the flow proceeds to step S1010. On the other hand, in a case where it is determined that all blocks have not yet been completely processed, the flow proceeds to step S1009.

Next, in step S1009, the CPU 108 increments the current block coordinates by one block. For example, the image is scanned from left to right and from top to bottom. The horizontal direction of the image is scanned from left to right, and in a case where the target reaches the right end, the target is moved to the left end of the block line that is one block below, and the image is scanned again from left to right. Using such a scanning method, the CPU 108 increments the block coordinates and sequentially performs filter processing from the upper left corner to the lower right corner of the image. In step S1010, the CPU 108 stores the image data for which the filter processing has been completed in the nonvolatile memory of the memory 105.

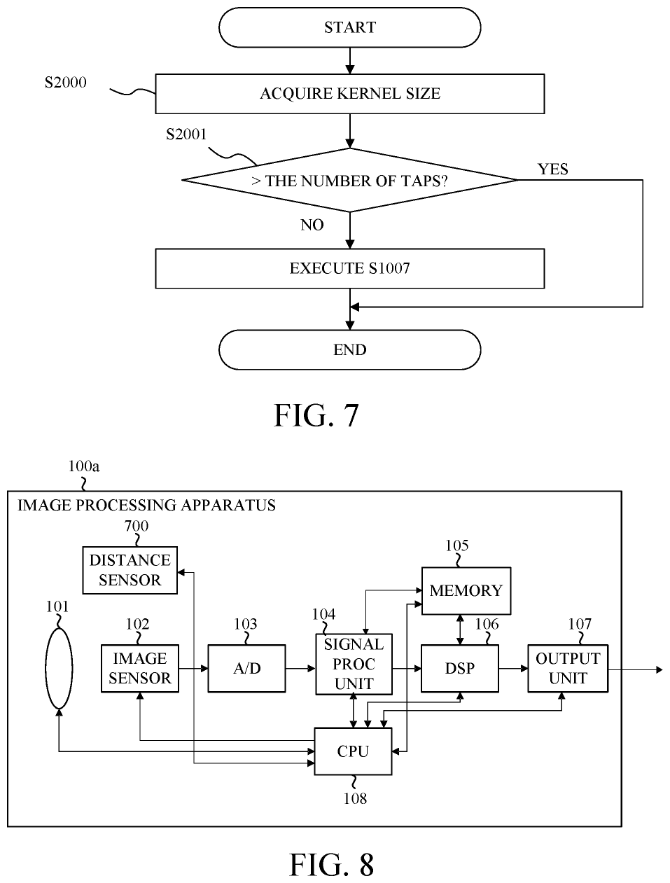

Step S1007 may include a step (determination processing) of determining whether or not to perform filter processing. FIG. 7 illustrates a flowchart in this case. FIG. 7 is a flowchart illustrating processing for determining whether to execute step S1007. A program based on the flowchart of FIG. 7 is recorded in the nonvolatile memory of the memory 105. This program is loaded into the RAM and executed by the CPU 108. The flowchart in FIG. 7 is executed after step S1006.

First, in step S2000, the CPU 108 obtains the kernel size of the filter processing to be executed in step S1007. As the distance from the in-focus position increases, the size of the blurred image increases, so the kernel size in performing filter processing also increases. As the kernel size increases, the processing load increases, so processing is limited to a certain size in order to perform processing in real time. By tagging the size of the filter kernel determined in step S1006 with the aberration providing filter table and by acquiring it, the size of the filter kernel can be acquired.

Next, in step S2001, the CPU 108 compares the kernel size and the number of taps for filter processing, and determines whether the kernel size exceeds the number of taps. In a case where it is determined that the kernel size exceeds the number of taps, the flow proceeds to step S1008 without executing step S1007. On the other hand, in a case where it is determined that the kernel size does not exceed the number of taps, the flow proceeds to step S1007. Thereby, processing based on the computing power of the image processing apparatus 100 can be achieved.

This embodiment uses an aberration providing filter with a pre-calculated design value, but may use an aberration characteristic of a point spread function (PSF) or OTF depending on a distance from the in-focus position, such as a defocus amount. In this case, the aberration providing filter table explained in step S1002 is replaced with the PSF table or OTF table. In addition, the CPU 108 directly calculates a filter kernel from a PSF or an OTF, thereby determining an aberration providing filter table (F12 or F21).

The optical information acquired from the imaging lens 101 in step S1002 may include information about an aberration state of a lens apparatus having a variable aberration mechanism. The filter kernel included in the aberration providing filter table may also be designed to include the aberration state of the lens apparatus having the variable aberration mechanism. Thereby, a difference between the front blurred image and the rear blurred image can be reduced in changing the aberration in the lens apparatus having the variable aberration mechanism. In other words, a soft-focus effect or a bubble blur effect can be applied to the entire area.

As described above, the image processing apparatus 100 performs filter processing that makes closer to each other the front blurred image and the rear blurred image (reduces a difference between the front blurred image and the rear blurred image) using the lens data, the aberration providing filter, and the defocus amount. Thereby, even for lenses whose front and rear blurs differ due to another design matter, such as a design of improving resolving power, an expression can be achieved in which front and rear blurs are similar as in an old lens.

### Second Embodiment

Referring now to FIG. 8, a description will be given of an image processing apparatus 100a according to a second embodiment. This embodiment will mainly discuss differences from the first embodiment, and omit common matters. This embodiment is the same as the first embodiment except for a difference in the configuration (method) for acquiring distance information about an in-focus position. In the first embodiment, the method calculates the distance information about the focus position based on the imaging-surface phase difference detected from the image sensor 102, but the data for calculating the distance information may be input data from a sensor other than the image sensor.

FIG. 8 is a block diagram of the image processing apparatus 100a. As illustrated in FIG. 8, this embodiment adds a distance sensor 700 to the image processing apparatus 100 of the first embodiment. The distance sensor 700 acquires distance information such as information about the object distance or phase difference (information about a defocus amount based on the phase difference).

The distance sensor 700 is, for example, at least one of a phase difference detecting sensor, a distance sensor, or a stereo camera, but is not limited to these examples. The distance sensor 700 can use Laser Range Finder (LRF), Light Detection And Ranging (LiDAR), etc., but is not limited to these examples. The stereo camera can use a plurality of cameras. By converting the distance information into a defocus amount by multiplying it by a predetermined coefficient in step S1005, the front and rear blurs can match in the same manner as in the first embodiment. Thus, in this embodiment, the distance information about the in-focus position can be acquired from the distance sensor 700 other than the image sensor 102.

### Third Embodiment

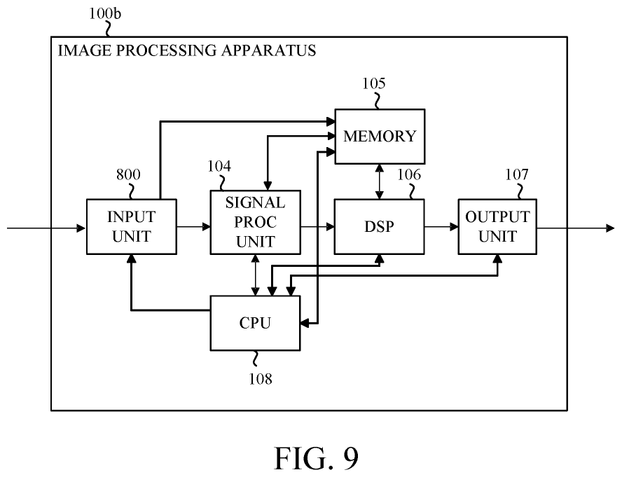

Referring now to FIG. 9, a description will be given of an image processing apparatus 100b according to a third embodiment. This embodiment will mainly discuss differences from the first or second embodiment, and omit common matters. This embodiment is similar to the first embodiment except for a configuration (method) for acquiring image data, optical information about the lens, and distance information about an in-focus position. In the first embodiment, optical information about the lens is acquired from the imaging lens 101, and image data is acquired using the image sensor 102. In the first embodiment, the method calculates the distance information about the focus position based on the phase difference data detected from the image sensor 102, but these data may be input data from the outside.

In completing internal processing by the DSP 106 or CPU 108, it may be difficult to execute a large number of complex processes due to hardware constraints. Accordingly, instead of using the imaging lens 101 and the image sensor 102, this embodiment acquires image data and necessary optical information about the lens, and performs filter processing on an application of a more accurate image processing apparatus such as a PC.

FIG. 9 is a block diagram of the image processing apparatus 100b. As illustrated in FIG. 9, in this embodiment, the image processing apparatus 100b includes an input unit 800 instead of the imaging lens 101, the image sensor 102, and the A/D converter 103. The input unit 800 acquires optical information about the imaging lens from an external device and transfers it to the memory 105. The input unit 800 also acquires image data and distance information about the in-focus position from the external device, performs proper signal processing via the signal processing unit 104, and then transfers the data to the memory 105. The optical information about the lens, the image data, and the distance information can be recorded on a medium in association with the image data as metadata, for example, and can be acquired by the input unit 800 as input from the medium. In the configuration and processing other than those described above, the front and rear blurs can be made closer to each other using the same method as in the first embodiment. Thus, this embodiment can acquire optical information about the imaging lens, image data, and distance information from the input unit 800.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment can provide an image processing apparatus that can properly express blurs and have high resolving power.

This application claims the benefit of Japanese Patent Application No. 2023-014919, filed on Feb. 2, 2023, which is hereby incorporated by reference herein in its entirety.

What is claimed is:

1. An image processing apparatus comprising:
a memory storing instructions; and
a processor configured to execute the instructions to:
acquire distance information about an in-focus position, and
perform filter processing using an aberration filter determined based on the distance information and optical information about an optical system, for image data acquired using an image sensor,
wherein the aberration filter has a parameter for adjustment that makes closer to each other a characteristic of a first blurred image formed on an image plane due to defocus on a close distance side of the in-focus position, and a characteristic of a second blurred image formed on the image plane due to defocus on an infinity side of the in-focus position.

2. The image processing apparatus according to claim 1, wherein the optical information includes information about at least one of an aperture diameter, zoom, and focus.

3. The image processing apparatus according to claim 1, wherein the optical information includes information about an aberration state on the image plane.

4. The image processing apparatus according to claim 1, wherein the parameter is a parameter for sharpening processing or blurring processing that makes closer to each other a spatial frequency characteristic of the first blurred image and a spatial frequency characteristic of the second blurred image.

5. The image processing apparatus according to claim 1, wherein the parameter is a parameter based on a combined function of an optical transfer function of the first blurred image and an inverse function of an optical transfer function of the second blurred image.

6. The image processing apparatus according to claim 1, wherein the parameter is a parameter for processing that makes closer to each other blurred sizes or blurred shapes of the first blurred image and the second blurred image, which have the same degree of the defocus.

7. The image processing apparatus according to claim 1, wherein the processor is configured to acquire an aberration characteristic based on the distance information and the optical information, and
wherein the parameter is a parameter based on the aberration characteristic.

8. The image processing apparatus according to claim 7, wherein the processor is configured to acquire the aberration characteristic from a lens apparatus having the optical system, an image pickup apparatus having the image sensor, or an external device.

9. The image processing apparatus according to claim 1, wherein the distance information is information about a defocus amount detected by an imaging-surface phase-difference detecting method using the image sensor.

10. The image processing apparatus according to claim 1, wherein the distance information is information about a defocus amount detected by a phase-difference detecting sensor.

11. The image processing apparatus according to claim 1, wherein the distance information is information about an object distance detected by a distance sensor.

12. The image processing apparatus according to claim 1, wherein the processor performs the filter processing for each divided area in the image data.

13. The image processing apparatus according to claim 1, wherein the processor is configured to acquire the number of taps of a filter kernel in the filter processing, and does not perform the filter processing in a case where it is determined that the number of taps is insufficient.

14. An image pickup apparatus comprising:
an image sensor;
a memory storing instructions; and
a processor configured to execute the instructions to:
acquire distance information about an in-focus position, and
perform filter processing using an aberration filter determined based on the distance information and optical information about an optical system, for image data acquired using an image sensor,
wherein the aberration filter has a parameter for adjustment that makes closer to each other a characteristic of a first blurred image formed on an image plane due to defocus on a close distance side of the in-focus position, and a characteristic of a second blurred image formed on the image plane due to defocus on an infinity side of the in-focus position.

15. The image pickup apparatus according to claim 14, wherein the optical information includes information about at least one of an aperture diameter, zoom, and focus.

16. The image pickup apparatus according to claim 14, wherein the optical information includes information about an aberration state on the image plane.

17. An image processing method comprising the steps of:
acquiring distance information about an in-focus position, and
performing filter processing using an aberration filter determined based on the distance information and optical information about an optical system, for image data acquired using an image sensor,
wherein the aberration filter has a parameter for adjustment that makes closer to each other a characteristic of a first blurred image formed on an image plane due to defocus on a close distance side of the in-focus position, and a characteristic of a second blurred image formed on the image plane due to defocus on an infinity side of the in-focus position.

18. The image processing method according to claim 17, wherein the optical information includes information about at least one of an aperture diameter, zoom, and focus.

19. The image processing method according to claim 17, wherein the optical information includes information about an aberration state on the image plane.
